(19) United States
(12) Patent Application Publication
(10) Pub. No.: US 2015/0166883 A1
(43) Pub. Date: Jun. 18, 2015

(54) PHOTOLUMINESCENT COMPOSITIONS AND USES THEREOF

(71) Applicant: Justin Krook, Lunenberg, MA (US)

(72) Inventor: Justin Krook, Lunenberg, MA (US)

(21) Appl. No.: 14/542,016

(22) Filed: Nov. 14, 2014

Related U.S. Application Data
(63) Continuation of application No. PCT/US2013/041133, filed on May 13, 2014.
(60) Provisional application No. 61/737,912, filed on Dec. 17, 2012.
(60) Provisional application No. 61/677,575, filed on Jul. 31, 2012.
(60) Provisional application No. 61/647,683, filed on May 16, 2012.

(51) Int. Cl. C09K 11/02; C09K 11/77

(52) U.S. Cl. CPC C09K 11/025; C09K 11/7734

(57) ABSTRACT

A highly-visible photoluminescent composition with long-lasting light output. The composition has photoluminescent particles suspended in an essentially clear medium that is adapted to transmit light emitted by the photoluminescent particles. The light emitted from the composition, averaged across at least three samples, exceeds the ASTM E2072 minimum brightness ratings at both 10 and 30 minutes by at least about three times.

### RELATED APPLICATIONS

This application is a continuation of International Application No. PCT/2013/041133, filed on May 15, 2013, which claims priority to U.S. Provisional Patent Application No. 61/647,683, filed on May 16, 2012, U.S. Provisional Patent Application No. 61/677,575, filed on Jul. 31, 2012, and U.S. Provisional Patent Application No. 61/737,912, filed on Dec. 17, 2012. The contents of each of these aforementioned applications is incorporated herein by reference in their entirety.

### FIELD OF THE INVENTION

This disclosure relates to photoluminescent compositions.

### BACKGROUND

There are many situations where visibility in low light and poor lighting conditions is useful or important. Examples include night-time, foggy and smoky conditions. In cases in which electrical lighting is not present or cannot be used, such visibility can be hard to accomplish.

### SUMMARY

This disclosure features photoluminescent/phosphorescent compositions, beneficial uses of such compositions, and articles and objects that carry such compositions. The photoluminescent/phosphorescent compositions have very strong and long-lasting light output. They can be applied to surfaces that are exposed to sunlight and weather. They glow after dark for hours, and thus are useful to allow for detection of objects and articles that carry the composition at night or in the dark or under reduced lighting conditions. The compositions are typically applied to the articles and objects as a viscous liquid. The compositions typically harden to a solid state.

### DETAILED DESCRIPTION OF EXAMPLES

This disclosure features photoluminescent/phosphorescent compositions, beneficial uses of such compositions, and articles and objects that carry such compositions. The photoluminescent/phosphorescent compositions have very strong and long-lasting light output. They can be applied to surfaces that are exposed to sunlight and weather. They glow after dark for hours, and thus are useful to allow for detection of objects and articles that carry the composition at night or in the dark or under reduced lighting conditions. The compositions are typically applied to the articles and objects as a viscous liquid. The compositions typically harden to a solid state.

Examples of the subject photoluminescent composition exhibit very strong brightness. Examples of the subject photoluminescent composition exhibit very strong brightness for an extended period of time. Examples of the subject photoluminescent composition exhibit brightness that exceeds the requirements of standardized testing for photoluminescent markings used for safety purposes such as safety signs and the like.

These advantages are accomplished with a composition in which photoluminescent particles are suspended in an essentially clear medium that is adapted to transmit light that is emitted by the photoluminescent particles. The optical clarity of the medium also allows penetration of the composition by light; the light is absorbed by the photoluminescent particles so as to recharge their capacity to emit light.

In one example, the light emitted from the composition, averaged across at least three samples, exceeds the ASTM E2072 minimum brightness ratings at both 10 and 30 minutes by at least three times. In another example, the photoluminescent light emitted from the composition, averaged across at least three samples, exceeds the ASTM E2072 minimum brightness rating at 10 minutes by at least eight times. In one example, the photoluminescent light emitted from the composition, averaged across at least three samples, exceeds the ASTM E2072 minimum brightness rating at 30 minutes by at least fifteen times.

In another example, the photoluminescent light emitted from the composition, averaged across at least three samples, exceeds the ISO 17398:2004 sub-classification D minimum brightness ratings at 2, 10, 30 and 60 minutes, and exceeds the 60 minute brightness rating by at least two times. In another example, the photoluminescent light emitted from the composition, averaged across at least three samples, exceeds the ISO 17398:2004 sub-classification D minimum brightness rating at 10 minutes by at least one and one-half times. In another example, the photoluminescent light emitted from the composition, averaged across at least three samples, exceeds the ISO 17398:2004 sub-classification D minimum brightness rating at 30 minutes by at least one and one-half times. In another example, the photoluminescent light emitted from the composition is maintained at a luminance of at least 150 mcd/m² for at least 30 minutes.

The intensity of the glow of the compositions is believed to be due to several factors. One is the transparency; it seems the clearer the medium the brighter the glow. Also, when the composition is applied on top of a white or light-colored substrate or primer the result is bright. Because the applications tend to be thin and are clear, a dark substrate is visible and makes it appear not as bright. Also, solids loading has an effect: typically herein the solids loading is 50-100% based on the weight of the medium, and the particle size range is typically 80% of 150-200 micron powder and 20% of 85-100 micron powder. In some case all of the particles are in the 150-200 micron range.

The viscosity of the medium is also a factor. Because the pigment is heavy, the more viscous the medium the better the suspension of the solids and thus the brightness is better and more uniform across the surface of the composition (because the solids are less likely to settle or shift as the medium hardens. Using a Brookfield Viscometer model 4-6, the best results start at 25,000 cP up to 150,000 cP. When the viscosity is less than 25,000 cP the particles tend to sink before the medium hardens and therefore it can be difficult to have them evenly spread through the volume of the hardened composition. If the pigment is not evenly spread the glow is uneven. When the composition has a viscosity of around 25,000 cP, it can be coated onto a fabric of other flexible substrate by the well-known knifing process where the composition is applied to the moving substrate using a straight edge or “knife” that is set to a certain height above the substrate so as to leave a uniform thickness of composition on the substrate. The medium with 150,000 cP viscosity can be used for screen printing where sharp clean edges are desired.

When the medium includes UV inhibitors (or is UV stable) less UV light penetrates the composition so the intensity of the glow is lessened. Because the pigment absorbs the UV, the pigment itself helps to act as a UV “inhibitor” for the medium and therefore protect the medium itself.

The medium that is being used should be a 100% solid material. This means as the curing takes place zero or very little evaporation takes place. If a medium with less than 100% solids is used, the evaporation that takes place leaves the pigment exposed, creating a rough surface on the cured composition. With mediums that are not 100% solids, a clear coat can be applied to the exposed surface after curing so as to protect the surface.

The essentially clear medium of the photoluminescent composition may be an epoxy. The epoxy may be a two-part epoxy. The medium can alternatively be a urethane, a plastisol, a UV curable medium or a flame retardant material. Optical brighteners can be used to enhance the daytime colors. The photoluminescent particles may comprise SrCO₃ and EuO₃. The photoluminescent composition may further comprise Al₂O₃.

Other examples herein include articles of commerce that include any of the compositions discussed herein.

Examples of the subject compositions (made per Example II below) were tested according to both ASTM E2072 and ISO 17398:2004. Three separate samples were tested. The results are reported as set forth in Tables 1 and 2, respectively.

TABLE 1
ASTM E2072

| | Luminance (mcd/m²) | Luminance (mcd/m²) |
|---|---|---|
| Specimen | at 10 minutes | at 30 minutes |
| Minimum required | 20 | 2.8 |
| luminance | | |
| Specimen 1 | 155.8 | 47.1 |
| Specimen 2 | 170.5 | 53.2 |
| Specimen 3 | 174.4 | 52.2 |
| Average of 3 specimens | 166.9 | 50.8 |

TABLE 2
ISO 17398: 2004

| | Luminance | Luminance | Luminance | Luminance |
|---|---|---|---|---|
| | (mcd/m²) at | (mcd/m²) at | (mcd/m²) at | (mcd/m²) at |
| Specimen | 2 minutes | 10 minutes | 30 minutes | 60 minutes |
| Minimum | 1,100 | 260 | 85 | 35 |
| required | | | | |
| luminance for | | | | |
| Sub-classifi- | | | | |
| cation “D” | | | | |
| Specimen 1 | 1,373 | 454 | 157 | 76 |
| Specimen 2 | 1,444 | 522 | 186 | 86 |
| Specimen 3 | 1,388 | 472 | 177 | 83 |
| Average of 3 | 1,401 | 483 | 173 | 82 |
| specimens | | | | |

As is apparent, the luminance exceeds the requirements at each measured time period. The composition thus exhibits high luminance initially, and the high luminance is maintained for an extraordinarily long time. These features allow the composition to be used in applications in which photoluminescent material has not heretofore been thought appropriate for use.

### Example I

Plastisol can be used to accomplish a very flexible composition. A solid strip or sheet of flexible material can be made by starting with a plastisol base with a viscosity of about 20,000 cP. To this is added and mixed in about 75-100% of 150-200 um size of the photoluminescent material particles, and from 0-25% of 85-100 um size. The mixture is then poured on the textile or substrate and knifed to the desired thickness, which is typically from about 0.6 to about 0.75 mm. The coated substrate is then placed in an oven and cured for about 5 minutes at 250° F. Once cured and depending on the use a protective clear-coat can be applied; typically the clear-coat is UV curable cured in about 30 seconds.

Plastisol material can also be screen printed. Typically, though, to achieve sharp edges it is desirable to screen print with thicker material, such as plastisol with a viscosity of about 150,000 cP. This material can be accomplished by mixing about 60% of a plastisol with a viscosity of greater than 150,000 cP with about 40% of the above-motioned 20,000 cP plastisol. After mixing together the two plastisols, the 150-200 um photoluminescent material is added and mixed in. When screen printing is used to apply the composition, a 50 mesh screen is used. This is cured by heat, 225° F. for 2-4 minutes. The clear coat can be applied as needed. If clear coat is applied curing of the composition and clear coat all together can alternatively take place after its application.

For use with firefighters the composition needs to be heat resistive (needs to withstand 500° F. for 5 minutes). An appropriate composition can comprise a silicone textile ink and catalyst system (e.g., Dow Corning Silicone Textile Ink) with 150-200 um photoluminescent material. The article is cut into strips and sewn onto clothing or gear, or the composition can be applied by screen printing and then cured with heat, 275° F. for 1 minute.

### Example II

One example of a photoluminescent/phosphorescent composition (which comprises a two-part epoxy) is formulated as follows.

The medium of this example comprises a two-part epoxy formulation (part A and part B) comprising a compound ingredient and a hardener ingredient that are mixed together to react and harden. A photoluminescent powder is mixed into the epoxy, and the viscous mixture is applied to an article, object or location of interest. The powder can be mixed into part A, or into part B, or into the two parts of the epoxy after they have been mixed together, or the powder and the two parts of the epoxy can be mixed together all at once. It is best to mix part A with powder then part B with powder separately as this can help get rid of any air that has been trapped while mixing; once parts A and B are mixed together there may not be enough time to try extracting the air before the product sets up. An ultrasonic processor can be used to remove entrained air.

A useful epoxy formulation is as follows.

1) Part A—Epoxy Resin: Polymer of Epichlorhydrin & Bisphenol A that includes Surface Active Agents, Defoamers, Alkyl Glycidyl Ether (C12-C14) and Non Reactive Fillers (Fumed Silica).
2) Part B—Curing Agent: Amine Hardener. Includes Polyoxypropylamine, Surface Active Agents, N-Aminoethylpiperazine, Poly-Aminoamide, Bisphenol A, Nonyl Phenol and Non Reactive Fillers.
3) The photoluminescent pigment is an alkaline earth metal aluminate powder that comprises a combination of Al₂0₃ (CAS Number 1344-28-1), SrCO₃ (CAS number 1633-05-2) and Eu₂0₃ (CAS number 1308-96-9). The powder is formulated with the following percentages of the particular particle sizes: 25% of 85-100 micron powder, 50% of 150-200 micron powder, and 25% of 350-450 micron powder. This photoluminescent pigment formulation has been found to be particularly bright with a long-lasting photoluminescence. The combination of the different sized particles provides the best results with regard to brightness and a smooth finish. With too many large particles, while bright, it is difficult to create a uniform glow and smooth finish, while combining the medium and small particles helps to retain the brightness. The epoxy is present as about 56-58%) of the mixture and the pigment the balance of about 42-44%.

### Example III

### Third Composition (Epoxy Medium) Formulation:

This composition is very flexible. In this composition a two-part epoxy is used as the medium. Part A of the epoxy is the same as in the Example I formulation. Part B is a different hardener and comprises a product from Huntsman International LLC called “Aradur 77” which contains the following ingredients: 2855-13-2 Cyclohexanemethanamine, 5-amino-1,3,3-trimethl-; 61788-46-3 Amines, coco alkyl; 84852-15-3 Phenol, 4-nonyl-,branched; 90-72-2 Phenol, 2,4,6-tris[(dimethlamino)methyl]-.

The epoxy is formulated with from 40-50%) part A and from 50-60%) part B. Otherwise the formulation and pigmentation is the same as in Example I. This formulation II is flexible and soft as compared to the first formulation, which is hard, stiff and rigid.

A test of application and flexibility was as follows. A 2″ wide and 6′ long strip of VELCRO™ material meant to have adhesive applied to its back side had a layer of this composition II about 1/16″ thick applied in place of adhesive. After a 24 hour cure time the strip could be folded in half without the dried composition cracking.

Some of the uses would be to apply the composition to separate strips that are then used as desired, or to directly apply the composition to clothing such as safety vests or garment. This would change existing reflective stripes such that they now became visible without a light. It could also be made into long pieces (e.g., a tough material such as Nylon or perhaps strips of a hook and loop-type fastener material such as VELCRO™) that are cut to desired length and then used, e.g., sewn or adhered onto clothing or other objects or articles. It could be made into sheets, then logos or symbols could be cut out of the sheets. An adhesive applied to back of the sheets could be used to adhere the pieces, e.g., as stickers on helmets that would make the helmets or other clothing or objects worn on the person visible in the dark.

### Examples of Additional Applications/Uses of the Photoluminescent Compositions

The following non-limiting examples of real world products that the photoluminescent compositions have been applied to and could be applied to are exemplary and not limiting of the scope of the disclosure, as the photoluminescent compositions can be applied to other objects and used for other applications.

As two examples, the photoluminescent epoxy-based compositions of Example I has been applied to include granite and concrete curbs, as follows. The curbs were first cleaned with a vacuum to remove top surface dust and dirt. A solution of concrete cleaner was used to scrub the curbs, which were then rinsed using plenty of clean water sprayed from a hose. After the curbs dried, they were taped to help define a straight edge to the applied area. The areas to be coated were then primed with an acrylic/urethane bonding primer-sealer tinted white (two coats); this not only primes the surface but also brightens the surface to help the photoluminescent glow to be as bright as possible.

The particular formulation of the epoxy medium of Example I was as follows: 200 g (about 70%) of part A and 84 g (about 30%) of Part B. Also, 112 g of 150-200 micron photoluminescent pigment powder, 56 g of 350-450 micron photoluminescent pigment powder and 55 g of 85-100 micron photoluminescent pigment powder. All of the ingredients were then mixed together so as not to entrain too much air in the composition. The mixture was then poured out over the primed curb and spread with a plastic putty knife. The surface was then spritzed with xylol (xylol helps to make the surface slippery to allow it to be smoothed and spread more evenly, without affecting the adhesion and durability) and smoothed with a putty or drywall knife. After the mixture hardened (about three hours) the surface was rolled with a mixture of acrylic concrete curing and sealing compound and a gritty non-slip micronized polymer additive, to both seal the surface and provide a non-slip surface.

The result was a stripe of photoluminescent material on the surface of the curb. At nighttime the curb glowed for twelve or more hours; the color was a soft safety lime green. The curb was visible from as much as about two hundred feet away.

Other examples of products to which the compositions can be applied include: stairways, sidewalks, pathways, fire hydrants, signs, guard rails, DPW trucks, firefighting helmets, tools and ladders, fishing lures, and jewelry. Other applications for the compositions include passive lighting for stairwells, passive lighting for outdoor pathways, fire hydrant indicators, decorative signs (e.g., house numbers), lawn and garden decorations, firefighter equipment (e.g., tools, helmets etc.), fishing lures, street signs, street lines, clothing, safety glow reflectors (e.g., bikes, shoes, belts, hats, telephone poles etc.), boat equipment, piers, toys, diving equipment, driveway markers, parking garage signs and lines, police vehicles, camping gear, curbs, passive lighting (e.g., for stadiums and movie theaters), and chair lift poles and trail markers for night skiing.

Further, the formulation of Example II, being quite flexible, can be applied to objects and articles that are themselves flexible, such as clothing. Examples include safety vests for road crews and other similar applications.

The above examples and exemplifications are not limiting of the scope of the disclosure, rather they simply illustrate the disclosure. The scope is fully set forth in the claims.

What is claimed is:

1. A highly-visible photoluminescent composition with long-lasting light output, comprising:
photoluminescent particles suspended in an essentially clear medium that is adapted to transmit light emitted by the photoluminescent particles;
wherein the light emitted from the composition, averaged across at least three samples, exceeds the ASTM E2072 minimum brightness ratings at both 10 and 30 minutes by at least three times.

2. The photoluminescent composition of claim 1 wherein the light emitted from the composition, averaged across at least three samples, exceeds the ASTM E2072 minimum brightness rating at 10 minutes by at least eight times.

3. The photoluminescent composition of claim 2 wherein the light emitted from the composition, averaged across at least three samples, exceeds the ASTM E2072 minimum brightness rating at 30 minutes by at least fifteen times.

4. The photoluminescent composition of claim 1 wherein the light emitted from the composition, averaged across at least three samples, exceeds the ISO 17398:2004 sub-classification D minimum brightness ratings at 2, 10, 30 and 60 minutes, and exceeds the 60 minute brightness rating by at least two times.

5. The photoluminescent composition of claim 4 wherein the light emitted from the composition, averaged across at least three samples, exceeds the ISO 17398:2004 sub-classification D minimum brightness rating at 10 minutes by at least one and one-half times.

6. The photoluminescent composition of claim 5 wherein the light emitted from the composition, averaged across at least three samples, exceeds the ISO 17398:2004 sub-classification D minimum brightness rating at 30 minutes by at least one and one-half times.

7. The photoluminescent composition of claim 1 wherein the light emitted from the composition is maintained at a luminance of at least 150 mcd/m² for at least 30 minutes.

8. The photoluminescent composition of claim 1 wherein the medium comprises an epoxy or a plastisol.

9. The photoluminescent composition of claim 8 wherein the medium is a two-part epoxy.

10. The photoluminescent composition of claim 9 wherein the photoluminescent particles comprise SrCO₃ and EuO₃.

11. The photoluminescent composition of claim 10 further comprising Al₂O₃.

12. The photoluminescent composition of claim 8 wherein the medium is plastisol and the solids loading is 50-100% based on the weight of the plastisol, and where at least about 80% of the particles have a particle size of from about 150 to about 200 microns.

13. The use of the composition of claim 1 on a structure selected from the group of structures consisting of curbs, stairways, sidewalks, pathways, fire hydrants, signs, guard rails, DPW trucks, firefighting helmets, tools and ladders, fishing lures, and jewelry, stairwells, outdoor pathways, fire hydrants, decorative signs, lawn and garden decorations, firefighter equipment, fishing lures, street signs, street lines, clothing, safety glow reflectors, boat equipment, piers, toys, diving equipment, driveway markers, parking garage signs and lines, police vehicles, camping gear, curbs, passive lighting, chair lift poles and ski trail markers.

14. A photoluminescent substance, comprising:
a two-part epoxy, with part A and part B, wherein part A comprises an epoxy resin comprising a polymer of epichlorhydrin and bisphenol A that may include a surface active agent, a defoamer, an alkyl glycidyl ether (C12-C14) and a non-reactive filler, and part B comprises a curing agent comprising an amine hardener comprising polyoxypropylamine, and may include a surface active agent, N-aminoethylpiperazine, poly-aminoamide, bisphenol A, nonyl phenol, and a non-reactive filler; and
a photoluminescent pigment comprising an alkaline earth metal aluminate powder that comprises a combination of Al₂O₃, SrCO₃ and Eu₂O₃ formulated with the following percentages of the particular particle sizes: about 25% of 85-100 micron powder, about 50% of 150-200 micron powder, and about 25%) of 350-450 micron powder;
wherein the two parts of the epoxy and the pigment are thoroughly mixed, and the mixture is applied to a surface and allowed to harden.

15. The substance of claim 14 comprising about 56-58%) epoxy and about 42-44% pigment.

16. The substance of claim 15 wherein the epoxy comprises about 70% part A and about 30% part B.

17. A photoluminescent substance, comprising:
a two-part flexible epoxy, with part A and part B, wherein part A comprises an epoxy resin comprising a polymer of epichlorhydrin and bisphenol A that may include a surface active agent, a defoamer, an alkyl glycidyl ether (C12-C14) and a non-reactive filler, and part B comprises a curing agent comprising an amine hardener; and
a photoluminescent pigment comprising an alkaline earth metal aluminate powder that comprises a combination of Al₂O₃, SrCO₃ and Eu₂O₃;
wherein the two parts of the epoxy and the pigment are thoroughly mixed, and the mixture is applied to a surface and allowed to harden.

18. The substance of claim 17 comprising about 56-58% epoxy and about 42-44% pigment.

19. The substance of claim 18 wherein the epoxy comprises about 40-50%) part A and about 50-60% part B.

20. The substance of claim 17 wherein the pigment is formulated with the following percentages of the particular particle sizes: about 25% of 85-100 micron powder, about 50% of 150-200 micron powder, and about 25% of 350-450 micron powder.
